(19) United States
(12) Patent Application Publication
(10) Pub. No.: US 2004/0229561 A1
(43) Pub. Date: Nov. 18, 2004

(54) Tuner

(76) Inventors: Nicholas Paul Cowley, Wroughton (GB); Keith Lloyd Jones, Pinner (GB)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025, US

(21) Appl. No.: 10/788,007

(22) Filed: Feb. 25, 2004

(30) Foreign Application Priority Data
Feb. 28, 2003 (GB) 0304584.6

(51) Int. Cl. H04B 1/10

(52) U.S. Cl. 455/3.01; 455/3.06

(57) ABSTRACT

A tuner is provided for selecting for reception any one of a plurality of channels in a broadband radio frequency signal supplied to its input. The tuner comprises a plurality of stages, at least some of whose gains and power consumptions can be adjusted by a controller in accordance with prevailing reception conditions. A frequency changer and variable gain amplifier provide a first filtering arrangement to reject non-adjacent channels and a tuneable filter rejects substantially all but the selected channel. Signal levels before the first filtering arrangement, between the first filtering arrangement and a second filtering arrangement formed by the tuneable filter, and after the second arrangement are supplied to the controller, which adapts the gain structure and/or individual stage power consumptions according to the prevailing reception conditions so as to provide an adequate performance for demodulation while reducing power consumption when extreme reception conditions are not encountered.

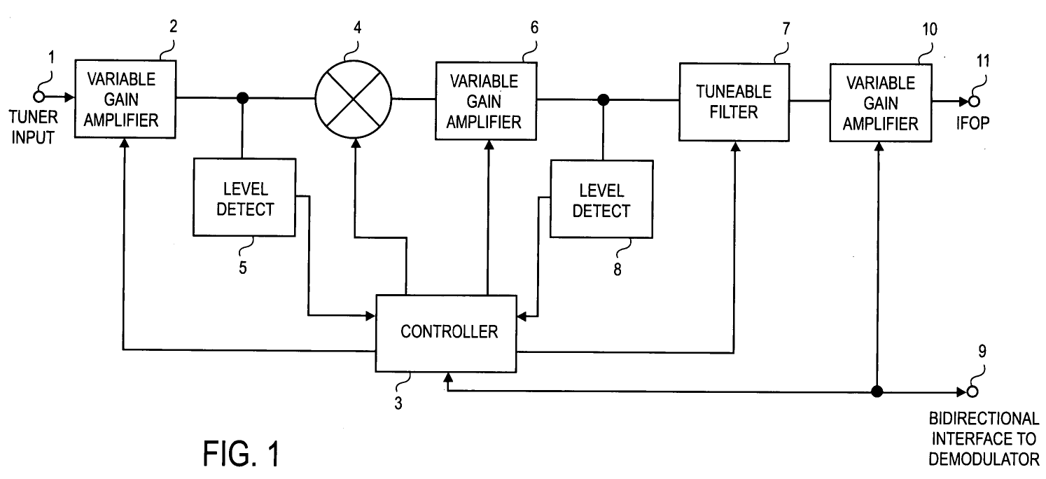

### TECHNICAL FIELD

The present invention relates to a timer for selecting for reception any one of a plurality of channels in a broadband radio frequency input signal. Such tuners may be used in set-top boxes and inside television equipment such as receivers and video recorders to receive digital television and audio broadcasts from terrestrial, cable and satellite sources.

### BACKGROUND

Radio frequency tuners are used to select a desired channel for reception and to convert this to a predetermined intermediate frequency, which is then supplied to a digital demodulator for recovery of video or audio signals. A known type of tuner converts the selected channel to zero intermediate frequency. Such tuners are required to meet a minimum level of performance in order to deliver acceptable demodulated video or audio quality over a widely varying range of reception conditions.

In broadcast digital terrestrial transmissions, digital television channels are typically broadcast in vacant channels between analog television channels. In such known arrangements, the digital channel is typically transmitted at a lower power than the analog channels so as to prevent degradation of reception of the analog channels. For example, it is typical for the analog channels on both sides of and immediately adjacent a digital channel to be at a level of +36 dBc relative to the digital channel and for the next adjacent channels to be at a relative level of +46 dBc. In other systems, the digital channels may be broadcast independently of analog channels such that potentially interfering channels are not present or are of a similar or lower amplitude.

The received signals strengths of all of the channels may vary considerably, for example depending on the distance to the relevant transmitters, so that the conditions which a tuner faces cannot be predicted as it is dependent, upon other things, on the location of the tuner. Also, the total power in non-selected channels received at the input of a tuner can vary substantially from place to place and from time to time. Such tuners are therefore required to provide a sufficiently low noise figure (NF) and sufficiently low distortion products in the presence of a high amplitude composite interfering signal so as to be able to cope with a very wide range of received signal conditions.

In many known types of zero intermediate frequency tuners, frequency selective baseband filters are provided by integration onto one or more monolithic integrated circuits constituting the tuner. Known filters of this type tend to be noisy but have the advantage of removing unwanted potentially interfering channels and so provide a reduction in intermodulation distortion. The location of such filters in the tuner signal path is a compromise because, from noise considerations, it is desirable to maximise the gain upstream of such filtering whereas, from intermodulation distortion considerations, it is desirable to minimise the gain upstream of the filtering. A compromise has to be reached because many of the design requirements for low intermodulation and low noise figure are mutually exclusive.

In some known types of radio frequency tuners, relatively complex frequency-tracking filters are provided in the radio frequency section of the tuner and are controlled so as to track the frequencies of selected channels. Tracking filters do provide substantial attenuation to potentially interfering channels which are further in frequency from the selected channel and thus reduce the intermodulation distortion. An acceptable reception performance can then be achieved by operating various of the stages of the tuner at relatively high power or standing current to give an acceptable balance between noise figure and intermodulation performance. However, such tracking filters require alignment during production because of the inevitable manufacturing tolerances and this adds to the cost and complexity of tuner manufacture.

In the case of broadband tuners which are required to select any one of a plurality of channels occupying a relatively broadband spectrum, it is more difficult to implement radio frequency tracking filters. Accordingly, in order to provide adequate intermodulation performance, those stages ahead of, for example, intermediate frequency filtering are operated at higher power levels. Also, automatic gain control (AGC) techniques are used to vary the signal gain in one or more stages so as to provide acceptable intermodulation performance. In particular, automatic gain control is provided in the radio frequency stages so as to limit the signal levels applied to subsequent stages and gain reduction is required to start at relatively low input signal levels. However, this has the effect of degrading the noise figure.

The result of this is that known tuners generally operate at higher power consumption levels than would be required for most received signal conditions in order to be able to provide acceptable performance when faced with extremes of such conditions.

U.S. Pat. No. 4,580,288 discloses a receiver input circuit having a control loop for amplification control. The circuit comprises a first filtering arrangement 5 in the form of a tunable selective network which passes the selected channel and adjacent channels whilst attenuating non-adjacent channels. A second filtering arrangement 7 in the form of an intermediate frequency selective filter is provided downstream of the first filtering arrangement and has a narrower passband than the first filtering arrangement. A controller controls the gain of an input network and preamp on the basis of signal levels upstream of the first filtering arrangement, between the first and second filtering arrangements, and downstream of the second filtering arrangement.

### SUMMARY

According to the invention, there is provided a tuner for selecting for reception any one of a plurality of channels in a broadband radio frequency input signal, comprising a plurality of stages including: a first filtering arrangement which, in use, passes the selected channel and adjacent channels while attenuating non-adjacent channels; a second filtering arrangement downstream of the first filtering arrangement for passing the selected channel and for substantially rejecting non-selected channels at the input of the second filtering arrangement; and a controller for controlling at least one of the gain and the power consumption of at least one of the stages as a function of a first signal level upstream of the first filtering arrangement, a second signal level between the first and second filtering arrangements and a third signal level downstream of the second filtering arrangement.

The plurality of stages may comprise at least one frequency changer including a mixer and the first filtering arrangement may be downstream of the mixer. The controller may be arranged to control the power consumption of the mixer.

The at least one frequency changer may be arranged to convert the selected channel to zero intermediate frequency.

An amplifier may be disposed downstream of the at least one frequency changer and the first filtering arrangement may be provided in at least one of the at least one frequency changer and the amplifier. The controller may be arranged to control at last one of the gain and the power consumption of the amplifier.

The tuner may comprise a first level detector for detecting the first signal level upstream of the at least one frequency changer.

The tuner may comprise a first variable gain amplifier upstream of the at least one frequency changer, the controller being arranged to control the gain of the first variable gain amplifier. The controller may be arranged to control the power consumption of the first variable gain amplifier.

The tuner may comprise a second variable gain amplifier downstream of the second filtering arrangement. The gain of the second variable gain amplifier may be controlled in accordance with the third signal level.

The tuner may comprise a second level detector for detecting the second signal level.

The controller may have an input for receiving a signal representative of the third signal level from a demodulator for demodulating an output signal of the tuner.

The controller may be arranged to increase signal gain upstream of the first filtering arrangement when the first, second and third signal levels represent similar signal levels. The controller may be arranged to reduce power consumption upstream of the first filtering arrangement when the first, second and third signal levels represent similar signal levels.

The controller may be arranged to reduce signal gain upstream of the first filtering arrangement and/or to increase signal gain between the first and second filtering arrangements when the second and third signal levels represent similar signal levels and the first signal level represents a higher signal level.

The controller may be arranged to increase the power consumption upstream of the first filtering arrangement and/or to reduce power consumption downstream of the first filtering arrangement when the second and third signal levels represent similar signal levels and the first signal level represents a higher signal level.

The controller may be arranged to reduce signal gain upstream of the second filtering arrangement when the first and second signal levels represent similar signal levels and the third signal level represents a lower signal level.

The controller may be arranged to increase power consumption upstream of the second filtering arrangement when the first and second signal levels represent similar signal levels and the third signal level represents a lower signal level.

References herein to filtering arrangements “substantially rejecting” channels are intended to have the normal meaning in this technical field. In particular, non-selected channels are considered to be rejected if their signal levels are sufficiently attenuated to provide an acceptable reception performance for the selected channel.

It is thus possible to provide a tuner which is capable of providing an acceptable reception performance across a very wide range of signal reception conditions including relatively extreme conditions. In embodiments where the gain structure of the tuner is controlled in accordance with the signal levels, an acceptable reception performance can be provided in the presence of potentially interfering signals in adjacent and non-adjacent channels. In this respect, references to “adjacent channels” may include channels which are not only immediately adjacent the selected channel. Thus, such adjacent channels would include a plurality of channels which are generally contiguous with or adjacent each other, and include the selected channel. Non-adjacent channels are then channels which are further in frequency away from the selected channel.

In embodiments where the power consumption of one or more individual stages is controlled in accordance with the signal level, an adequate reception performance can be provided in a wide range of signal reception conditions including extreme conditions while reducing or minimising the power consumption of the tuner. Thus, the tuner power consumption can be adapted to the reception conditions so that it is not necessary for the tuner to be operated at a relatively high power level which, in many situations, would not be necessary to achieve adequate reception performance.

### BRIEF DESCRIPTION OF THE DRAWINGS

The accompanying drawing is a block circuit diagram of a radio frequency tuner constituting an embodiment of the invention.

### DETAILED DESCRIPTION

The tuner is intended for receiving broadband digital television or audio signals and has an input 1 for connection to a terrestrial or satellite aerial system or a cable distribution system. The tuner is illustrated as not having any selective radio frequency filtering in the radio frequency part or “front end”. However, in alternative embodiments, fixed frequency filtering such as low pass and/or high pass filters may be provided in the front end to attenuate signals beyond either or both edges of the broadband frequency spectrum containing the channels for reception. Alternatively or additionally, tracking radio frequency filters may be provided in the front end for tracking the frequency of the selected channel and for attenuating at least some non-selected channels. Because of the finite quality factor Q of such filters, component tolerances and the like, such filters pass a relatively broad range of frequencies including a substantial number of channels so that a relatively broadband signal would still be supplied by the tuner front end.

The tuner input 1 is connected to a first variable gain amplifier 2, which provides input impedance matching and a signal gain dependent on an automatic gain control (AGC) signal supplied by a controller 3. The amplifier 2 also has variable power consumption, for example implemented by varying the standing current of the amplifier, and the power consumption is also controlled by the controller 3. The output of the amplifier 2 is supplied to the input of a frequency changer 4 and to the input of a level detector 5, which detects the peak or RMS signal level in the broadband signal supplied by the amplifier 2 and supplies this to the controller 3. As an alternative, the input of the level detector may be connected to detect the signal level at the input of the amplifier 2. The signal level detected by the detector 5 thus represents the level of the complete received spectrum supplied to the tuner following amplification by the amplifer 2. The amplifier 2 may comprise a single AGC stage or a plurality of such stages and may comprise a single fixed gain stage or a plurality of fixed gain stages.

The tuner illustrated in the accompanying drawing is of the direct conversion zero intermediate frequency type which converts the selected channel in a single frequency conversion operation to zero intermediate frequency baseband in-phase I and quadrature Q signals, which are then processed by substantially identical parallel signal paths illustrated in the drawing as a single signal path for simplicity. However, other tuner architectures may alternatively be provided, such as single conversion or double conversion to near zero intermediate frequency, double conversion to zero intermediate frequency, and single or double conversion to a conventional intermediate frequency, for example of the order of several tens of MHz.

The frequency changer 4 may be of any suitable type and known frequency changers for direct conversion to zero intermediate frequency are well known in this technical field. For example, the frequency changer may comprise two mixers supplied with quadrature local oscillator signals derived from a single local oscillator controller by a phase-locked loop.

The frequency changer 4 supplies output signals in a restricted bandwidth so as to provide an initial degree of attenuation to non-selected channels, which are frequency-converted together with the selected channel. In a typical arrangement, a single low pass filter, for example of second order, has a cut-off frequency of a few times the data bandwidth of the selected channel, for example four times the data bandwidth.

The gain of the mixer or mixers in the frequency changer 4 may be variable and controlled by the controller 3. Alternatively, the mixer gain may be fixed. In either case, in the illustrated embodiment, the controller 3 controls the power level or consumption of the frequency changer 4, for example by controlling the standing current of one or more stages within the frequency changer 4. For example, the standing currents of the mixers may be controlled. However, the standing currents of other stages which generate and supply the local oscillator signals to the mixers may also be controlled.

The output of the frequency changer 4 is supplied to the input of a second variable gain amplifier 6, whose gain is controlled by the controller 3. The controller 3 also controls the power consumption of the amplifier 6, for example by controlling the standing current of one or more stages forming the amplifier 6. The amplifier 6 may comprise one or more gain control stages and one or more fixed gain stages. The amplifer 6 is also provided with a low pass characteristic of a type similar to that provided within frequency changer 4 and with a cut-off frequency similar to or having a predetermined ratio with that of the low pass filtering in the frequency changer 4.

The output of the amplifier 6 is supplied to a tuneable filter 7 and to a second level detector 8. The detector 8 detects the peak or RMS level of the signal at the output of the amplifier 6 and supplies this to the controller 3. The level detector 8 thus determines the signal level downstream of a first filtering arrangement comprising the filtering in the frequency changer 4 and the variable gain amplifier 6. The signal level is therefore a measure of the signal level of the selected channel and some of the adjacent channels. The more distant or non-adjacent channels are sufficiently attenuated by the first filtering arrangement such that their contribution to the signal level at the output of the amplifier 6 is negligible. In particular, the first filtering arrangement provides sufficient attenuation to more distant channels for such channels to be substantially rejected.

The tuneable filter 7 has a high order low pass characteristic so as to pass substantially only the selected channel and so as to provide sufficient attenuation to any other channels present at its input for these to be substantially rejected. Techniques for implementing such filters in an integrated circuit and for controlling the bandwidth are known in the technical field and will not be described further. The bandwidth or cut-off frequency of the filtering is controlled by the controller, for example in accordance with information supplied by a demodulator (not shown) to which the tuner is connected so that the tuneable filter 7 can be controlled in accordance with the channel bandwidth standard of the selected channel. For this and other purposes, the controller 3 is connected via a bidirectional interface 9 to a following demodulator. Although the signal gain of the filter 7 is normally fixed, it may also be controlled by the controller 3. Similarly, the power consumption of the filter 7 may be controlled by the controller 3.

For embodiments which use non-zero intermediate frequencies, the filter 7 may be a bandpass filter whose centre frequency and/or bandwidth may be controlled by the controller 3.

The output of the filter 7 is supplied to a third variable gain amplifier 10, whose output supplies an intermediate frequency output (IFOP) signal at a tuner output 11 for connection to the demodulator. The variable gain amplifier 10 may, for example, be of a similar type to the second variable gain amplifier 6. Although the gain and possibly the power consumption of the third variable gain amplifier 10 may be controlled by the controller 3, the gain in this embodiment is shown as being controlled effectively directly by a suitable control signal from the demodulator. The tuneable filter 7 constitutes a second filtering arrangement which effectively supplies only the selected channel at its output so that the variable gain amplifier 10 is only required to amplify the selected channel at the zero intermediate frequency to a level suitable for the demodulator. Techniques for adjusting the gain of the amplifier 10 by the demodulator are well known in this technical field and will not be described further. The power consumption of the amplifier 10 may be controlled by the controller 3.

Instead of or in addition to using the control signal from the demodulator, a further level detector may be provided to detect the signal level downstream of the filter 7. The detected level may be supplied to the controller 3 and/or may be used to control the amplifier 10 directly.

The controller 3 receives first, second and third signal levels from the first and second detectors 5 and 8 and from the demodulator, respectively, providing a measure of signal levels at different points within the filtering structure of the tuner. The first signal level represents the signal level in the broadband input signal, which includes all of the channels available for reception. The second signal level represents the level between the first and second filtering arrangements and this gives a measure of the signal level contributed by the selected channel and by adjacent channels, typically 6 to 8 adjacent channels. The third signal level represents the level of the selected channel determined from the signal supplied by the second filtering arrangement comprising the tuneable filter 7. The controller 3 compares these signal levels in order to control the gain structure and stage power consumptions of the tuner in accordance with a predetermined function so as to adapt or optimise the tuner performance to the prevailing reception conditions. For example, the signal levels may be converted to the digital domain and used to address a look-up table containing the function, for example in a read only memory (ROM). Any suitable pre-defined and pre-programmed or re-programmed function may be used to control the gain structure and the power consumption profile of the tuner and examples of suitable strategies are as follows.

If the reception conditions are such that only the selected channel is present in the input signal and all other channels (and any other interfering signals) contain little or no energy, the first, second and third signal levels represent similar signal levels or equivalent detected power levels. This condition of the signal levels is used by the controller 3 to infer that there are no substantial potentially interfering levels to generate intermodulation distortion. The controller 3 thus reduces the power consumption and maximises the gain of the first variable gain amplifier 2 so as to achieve a good noise figure with adequate distortion performance at relatively low operating power. The gain of the variable gain amplifier 6 may be adjusted to ensure an optimum signal level at the input of the tuneable filter 7 with the power consumption of the amplifier, together with the power consumption of the frequency changer and possibly also the power consumption of the filter 7, reduced to give an acceptable distortion performance.

In the case where there is substantial power in non-adjacent or “far out” channels, but little or no power in adjacent channels, similar levels are detected by the level detector 8 and the demodulator because the non-adjacent channels have been substantially rejected by the first filtering arrangement. However, the first signal level representing the power in the broadband input signal represents a higher input signal level. When these relative signal levels are detected by the controller 3, it infers that there are only “far-out interferers” and thus reduces the gain of the first variable gain amplifier 2 and possibly also increases the power consumption of the amplifier 2 so as to prevent or reduce intermodulation. However, the gain of the second variable gain amplifier 6 can be maximised and possibly its power consumption reduced as there is relatively little “undesired” power present in the signal supplied by the frequency changer 4. Similarly, if the power consumption of the tuneable filter 7 is controllable, this may also be reduced or minimised.

If the first and second signal levels indicate similar signal levels before and after the first filtering arrangement and the third signal level indicates a smaller signal level, the controller 3 infers that there is little energy in non-adjacent or far-out channels but there is substantial potentially interfering energy in the adjacent channels. In this case, the controller reduces the gains of the first and second variable gain amplifiers 2 and 6 and increases the power consumption in these amplifiers and possibly in the frequency changer 4 and the tuneable filter 7 so as to ensure an adequate intermodulation distortion performance.

It is thus possible to provide a tuner whose gain structure and power consumption distribution adapt to the prevailing signal reception conditions. In particular, it is not necessary to run the tuner at relatively high power consumption levels to accommodate extreme signal reception conditions even when such conditions do not apply. Thus, adequate performance can be provided across a wide range of reception conditions while reducing or minimising power consumption as compared with known tuner arrangements.

What is claimed is:

1. A tuner for selecting for reception any one of a plurality of channels in a broadband radio frequency input signal, said tuner comprising a plurality of stages including: a first filtering arrangement which, in use, passes said selected channel and adjacent ones of said channels while attenuating non-adjacent ones of said channels; a second filtering arrangement, disposed downstream of said first filtering arrangements and having an input, for passing said selected channel and for substantially rejecting non-selected ones of said channels at said input of said second filtering arrangement; and a controller for controlling at least one of a gain and a power consumption of at least one of said stages as a function of a first signal level upstream of said first filtering arrangement, a second signal level between said first and second filtering arrangements and a third signal level downstream of said second filtering arrangement.

2. A tuner as claimed in claim 1, in which said plurality of stages comprises at least one frequency changer including a mixer and said first filtering arrangement is downstream of said mixer.

3. A tuner as claimed in claim 2, in which said at least one stage comprises said mixer and said controller is arranged to control said power consumption of said mixer.

4. A tuner as claimed in claim 2, in which said at least one frequency changer is arranged to convert said selected channel to zero intermediate frequency.

5. A tuner as claimed in claim 2, comprising an amplifier disposed downstream of said at least one frequency changer, said first filtering arrangement being provided in at least one of said at least one frequency changer and said amplifier.

6. A tuner as claimed in claim 5, in which said at least one stage comprises said amplifier and said controller is arranged to control said at least one of said gain and said power consumption of said amplifier.

7. A tuner as claimed in claim 2, comprising a level detector for detecting said first signal level upstream of said at least one frequency changer.

8. A tuner as claimed in claim 2, in which said at least one stage comprises a variable gain amplifier upstream of said at least one frequency changer, said controller being arranged to control said gain of said variable gain amplifier.

9. A tuner as claimed in claim 8, in which said controller is arranged to control said power consumption of said variable gain amplifier.

10. A tuner as claimed in claim 1, comprising a variable gain amplifier downstream of said second filtering arrangement.

11. A tuner as claimed in claim ˜10, in which a gain of said second variable gain amplifier is controlled in accordance with said third signal level.

12. A tuner as claimed in claim 1, comprising a level detector for detecting said second signal level.

13. A tuner as claimed in claim 1, in which said controller has an input for receiving a signal representative of said third signal level from a demodulator for demodulating an output signal of said tuner.

14. A tuner as claimed in claim 1, in which said controller is arranged to increase said signal gain upstream of said first filtering arrangement when said first, second and third signal levels represent similar signal levels.

15. A tuner as claimed in claim 1, in which said controller is arranged to reduce said power consumption upstream of said first filtering arrangement when said first, second and third signal levels represent similar signal levels.

16. A tuner as claimed in claim 1, in which said controller is arranged to do at least one of reducing said signal gain upstream of said first filtering arrangement and increasing said signal gain between said first and second filtering arrangements when said second and third signal levels represent similar signal levels and said first signal level represents a higher signal level.

17. A tuner as claimed in claim 1, in which said controller is arranged to do at least one of increasing said power consumption upstream of said first filtering arrangement and reducing said power consumption downstream of said first filtering arrangement when said second and third signal levels represent similar signal levels and said first signal level represents a higher signal level.

18. A tuner as claimed in claim 1, in which said controller is arranged to reduce said signal gain upstream of said second filtering arrangement when said first and second signal levels represent similar signal levels and said third signal level represents a lower signal level.

19. A tuner as claimed in claim 1, in which said controller is arranged to increase said power consumption upstream of said second filtering arrangement when said first and second signal levels represent similar signal levels and said third signal level represents a lower signal level.
